(19) United States
(12) Patent Application Publication
(10) Pub. No.: US 2003/0021241 A1
(43) Pub. Date: Jan. 30, 2003

(54) Avionics audio network system

(76) Inventors: Stephen G. Dame, Everett, WA (US); Robert Jordan, Renton, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/190,445

(22) Filed: Jul. 5, 2002

Related U.S. Application Data
(60) Provisional application No. 60/303,364, filed on Jul. 6, 2001.

(51) Int. Cl. H04B 7/212

(52) U.S. Cl. 370/321; 370/442

(57) ABSTRACT

A communications system within a vehicle, typically an airplane, is provided. In one embodiment, the communications system comprises a plurality of nodes and wherein each node has a network interface component connected to a communication network. The communication network is configured to communicate data in a serial, time-division multiplexed (TDM) format using an embedded clock signal. Further, a primary master clock within one of the plurality of nodes provides a clock signal for the embedded clock signal for use with the TDM protocol. At least one input device is connected to one of the nodes and converts analog input to a digital format at a sample rate determined by the primary master clock. Additionally, at least one output device is also connected to one of the nodes and output device also converts digital data to an analog format at the same sample rate determined by the primary master clock.

### CROSS REFERENCE TO RELATED APPLICATION

This application is a continuing application of a prior U.S. provisional application Serial No. 60/303,364 filed on Jul. 6, 2001, priority from the filing date of which is hereby claimed under 35 U.S.C §120.

### FIELD OF THE INVENTION

The present invention pertains generally to avionics communications equipment, and more particularly to a system for providing advanced, networked digital audio/data communication between various devices within a modern aircraft cockpit and cabin environment.

### BACKGROUND OF THE INVENTION

Modern day aircraft have complex avionics systems that demand a high degree of training and procedural operation to provide the required safety and efficacy needed in piloting these vehicles. Although sophisticated systems have been developed for navigation (GPS, etc.), surveillance (Radar, etc.), communications (radio) and air traffic management, not as much emphasis has been paid to advancing the state of the art in the basic voice and audio communications systems on board these aircraft. Aircraft systems have a plethora of audio sources that need to be carefully and precisely mixed, gated, switched, and routed to various locations on the aircraft, and the complexity of installing and troubleshooting such an installation of wires and audio interface units is substantial with associated high costs. Most current aircraft systems also use analog circuits predominantly to achieve the above functions and these analog circuits tend to be custom to each specific aircraft's needs, form factors, mounting constraints, numbers of channels, etc. Analog system wiring is generally point-to-point except in the case of dedicated “tie-lines” for intercom operations. This leads to large bundles of wire and careful routing and separating of these wires from other noise producing components within an airframe fuselage. Frequently these systems also experience a high degree of audio cross talk between different channels of audio since long runs of parallel wires can produce capacitive and magnetic coupling between audio signals. The human hearing range is so sensitive that more than 80 dB of cross-talk rejection is needed to reduce cross-talk to acceptable levels. Once aircraft audio systems become certified with a particular aircraft they are not likely to be changed unless another major avionics upgrade is occurring for other mandatory reasons.

Although it is obvious that applying modern digital audio technology to this aircraft environment would be of benefit, it is not obvious to those skilled in the art as to how to construct such a digital architecture that would make it possible to simultaneously solve the problem of reducing point-to-point wiring count, providing an open systems architecture for mixing the plurality of various audio signals, providing emergency bypass functions for electronic malfunctions or power failures, implementing a redundant protocol and interconnect topology, limiting electromagnetic interference from digital network interconnects, establishing a protocol for low latency (time-delay from source to sink) audio paths, and synchronizing all of the various analog-to-digital and digital-to-analog circuits within a large distributed network of audio concentrators, pilot interface panels and accessories such as an audio power amplifier.

Recently the Rockwell Collins avionics company introduced a new suite of aircraft radios that incorporate a new breed of audio and data interconnect protocol based on the aircraft standard ARINC-429 for connecting two pieces of aircraft equipment together. Although this has been seen as a significant step forward for improving the quality of the radio equipment, little has been done towards establishing an architecture that connects these digital radio communication channels together to form a combined matrix of analog-to-digital sources with ARINC-429 digital communications channels in a comprehensive matrix of individual channels that can be routed together to any audio “node” within an aircraft system environment.

Very few digital audio systems exist for providing digital audio for avionics communications systems and none are known that incorporate a complete open matrix of connectivity. However, Honeywell has a proprietary system embedded in its Primus Epic system about which little is publicly known. Orbital Sciences makes and sells a DSP based audio system, but does not provide a network of audio channels to its panels. AvTech Corporation provides a time-division multiplex analog audio system based on older technology that provides an analog network of audio channels to various audio panels within its system, however because of the analog nature of that system it cannot also provide digital data or control information on the same wires.

### SUMMARY OF THE INVENTION

The invention is directed to a communications system within a vehicle, typically an airplane. In one embodiment, the communications system comprises a plurality of nodes, including both leaf nodes and hub nodes, wherein each node has a network interface component connected to a communication network. The communication network is configured to communicate data in a serial, time-division multiplexed (TDM) format using an embedded clock signal. Further, a primary master clock within one of the plurality of nodes, preferably a hub node, provides a clock signal for the embedded clock signal for use with the TDM protocol. At least one input device is connected to one of the leaf nodes and converts analog input to a digital format at a sample rate determined by the primary master clock. Additionally, at least one output device is also connected to one of the leaf nodes and the output device converts digital data to an analog format at the same sample rate determined by the primary master clock.

The present invention provides a digital audio communications system for communications applications. Accordingly, several advantages of the system are realized. First, an electrical interconnect methodology and technology, suitable to aviation environment conditions, provides over 100 channels of continuous streaming isochronous 16-bit digital audio data at a minimum sample rate of 8K samples per second per channel. Each channel is maintained synchronous by the use of a system-wide clock synchronization method whereby all nodes are synchronized to a single stable high-speed clock. This clock is then used on each device to provide synchronization for all input and output conversion devices to the digital audio communications system.

Further, the system includes a flexible channel allocation method of using integer numbers of the 8 KHz channels to achieve a mixed collection of sample rates (and thus higher bandwidth channels) based on integer multiples of 8 KHz throughout the system.

The method of networking multiple devices together consisting of hubs and leaf nodes where each hub repeats each signal it receives with a one TDM cycle delay achieves both low latency communications as well as selected redundancy for mission critical portions of an aircraft communications system.

Still further, the system uses an application of Low Voltage Differential Signaling (LVDS) technology and standardized serializer/deserializer chip sets in a unique manner to achieve moderately long distance transport of key synchronous serial signals. Use of a Phase Lock Loop stabilizer is provided in order to achieve system-wide low jitter and low bit error rates. Additionally, the use of doubly shielded, twin twisted pair cable bundles for bi-directional communications between two any two connected devices within the system is provided. Redundant connections require two such connections, usually coming from different hubs or from one hub and one leaf node in the system.

Finally, a flexible mix of audio and data on the same physical transport is provided so that all devices and channels in the system can be connected and accessed from any other point in the system. A system-wide matrix of audio and data channels that is completely open to access by any device within the system provides for mutually exclusive data producing channels that are established throughout the system and a secure method of accessing a mix of any other audio channel or access to any of the data channels. The matrix is configured through a routing methology and a static routing table that is stored under password protection on all devices within the system to prevent unauthorized tampering with a network configuration once it has been established for a particular aircraft configuration.

### BRIEF DESCRIPTION OF THE DRAWINGS

The foregoing aspects and many attendant advantages of this invention will become more readily appreciated as the same become better understood by reference to the following detailed description, when taken in conjunction with the accompanying drawings, wherein:

FIG. 1 is a block diagram of a typical system in accordance with an embodiment of the invention;

FIG. 2 is a diagram of typical time frame of a typical system communication packet as used in an embodiment of the invention;

FIGS. 3A-3D are block diagrams of typical components found in the system in accordance with embodiments of the invention; and

FIG. 4 is a block diagram of a typical application of the system in accordance with an embodiment of the invention.

### DETAILED DESCRIPTION

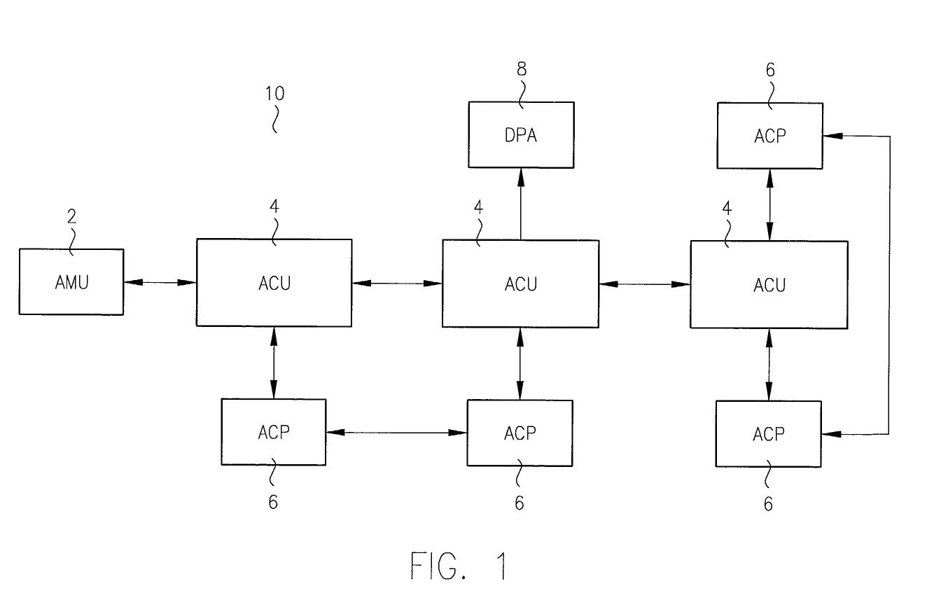

FIG. 1 shows a block diagram example of component configuration of a typical system 10. These components comprise Audio Concentrator Units (ACU) (hubs) 4, Audio Control Panels (ACP) 6, an Audio MultiFunction Unit (AMU) 2, and a Digital Power Amplifier (DPA) 8. Briefly, an Audio Concentrator Unit 4 connects to various digital and analog audio sources within the aircraft, providing hub functionality to the rest of the system so that any of the audio sources or sinks that are connected to each Audio Concentrator Unit 4 is accessible to the rest of the system. An Audio Control Panel 6 interfaces the system 10 channels to various personnel onboard the aircraft such as pilots, copilots, observers, and other assigned aircraft crew members. This is done typically through headphones, cabin speakers, microphones or other audio input/output devices. An Audio MultiFunction Unit 2 provides a number of audio playback features to the system 10 as well as a user interface to important digital audio control features, system setup and Controller Pilot DataLink Communications (CPDLC) for appropriately equipped (radio) systems. The Digital Power Amplifier 8 is a listen only accessory that receives data on one programmed set of channels, and then digitally incorporates Pulse Width Modulation (PWM) to provide a direct digital to power amplifier connection for clean reproducible power amplification. Each of these components is described in greater detail below.

To further understand the functionality of each component, the system 10 communication protocol must first be described in general. A typical system 10 provides several leaf nodes and hub nodes connected by a communication network configured to communicate data in a serial, time-division multiplexed (TDM) format. The communication network is characterized as a flexible and assignable matrix of redundant, bi-directional digital data transmission channels. Each channel carries data to and from each node. Examples of data that can be transmitted on the system 10 include a mix of 16-bit audio payload samples (of various sample rate formats) and other application specific data payloads such as system status information, Controller-Pilot DataLink Communication messages, etc.

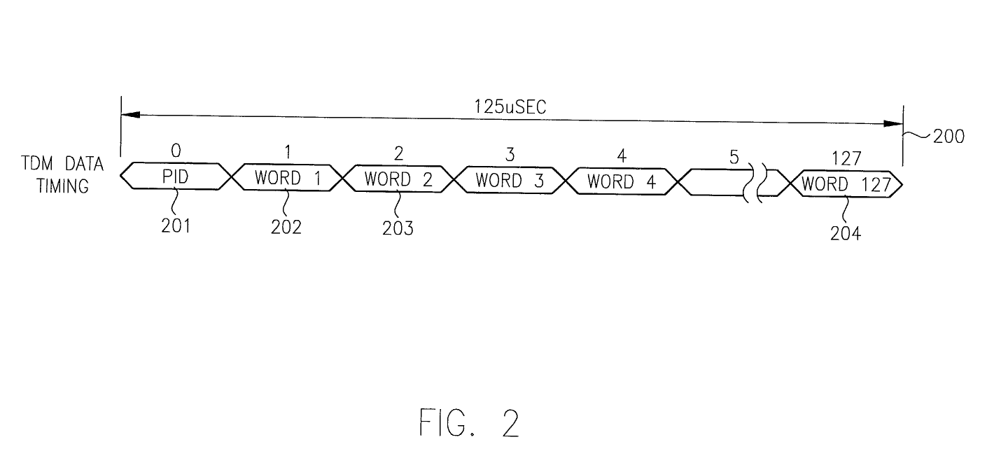

In accordance with an embodiment of the invention, at least 100 channels of 16-bit data are transmitted within a 125 microsecond (usec) frame of time. For example, FIG. 2 shows a single 125 usec frame 200 that is transmitted on the system 10. The first channel is always a PID (process identification) channel 201 that provides fault tolerant detection of a valid connection on the digital link thru the use of a 64 bit unique synchronization word that provides absolute marking of the first channel. Each channel word size is 16 bits, so this synchronization operation happens once 4 words representing the particular 64-bit code are received. Then the particular receiving node has confirmed it has a lock on the data stream. The PID channel is continuously monitors for this repeating 64-bit code which indicates the channel synchronization is being maintained. The second channel 202 contains a 16-bit piece of data called WORD 1, the third channel 203 contains another 16-bit piece of data called WORD 2 and so on until finally the 128^{th} channel 204, the last channel in this particular framing configuration, contains yet another 16-bit piece of data called WORD 127.

Sampling each channel source once every

125 usec gives an optimum 8 KHz sample rate for each data source. However, the flexibility of the system 10 allows for higher sample rates (thus higher quality audio in some applications) to be attained by allocating multiple channels to a single data stream. For example, a stereo 48 KHz music channel would occupy twelve 8 KHz data channels to transport the high quality stereo data from source to multiple destinations. In this matrix fashion, any combination of data requiring higher sampling rates can be communicated to any node in the matrix at any time.

The matrix form of the communication channels allows for a true multiple-to-multiple connection scheme where any number of devices on the system 10 can communicate with one another. Each device can be a producer of data on one or more assigned channels and/or a consumer of data on one or more assigned channels of the system 10. However, for data, and in particular audio data, to be played back in real time without noise or reproduction artifacts, it becomes necessary to provide a system wide clock for synchronicity.

Thus, in one embodiment, one of the devices on the system 10 is designated as the primary master of the bus and it provides a highly stable (2 ppm over the operating temperature range) system clock (SYSCLK) of 16.384 MHz. The SYSCLK is transmitted as an embedded clock with high-speed serial data from each node in the system. This is known in the industry as “Serialized data with embedded clock”. On the receiving end of each node in the system there is a corresponding “deserializer” capability that decodes the high speed serial data stream and separates the SYSCLK which is then sent to a narrow band phase lock loop (PLL) to stabilize the SYSCLK for use at the destination.

The SYSCLK signal is distributed to each of the nodes in the system so that each of the nodes can stream data samples into and out of other interfaces in the system with precise synchronization. Precise synchronization is important for audio and video applications, thus, the embedded clock signal ensures synchronous playback at each node that has an interface capable of receiving synchronous data. Typical examples of these interfaces include Sigma-Delta Codec chips, DSP processing elements and ARINC-429 interface elements for connecting with the Collins Proline 21 radio devices. Therefore, the system 10 provides not only a complete matrixed bus of data channels, but also a gateway interface to other types of systems that require precise sample rates such as Codec and Collins radio systems.

Typically, a single Audio Concentrator Unit 4 provides system clock mastership as a default master primary clock. If no failure of the primary master ever occurs, this Audio Concentrator Unit 4 will remain the clock master forever. However, if a default master ever fails to operate or a connection to the system 10 is lost, then a secondary master (typically designated in another Audio Concentrator Unit 4) takes over the system clock mastership.

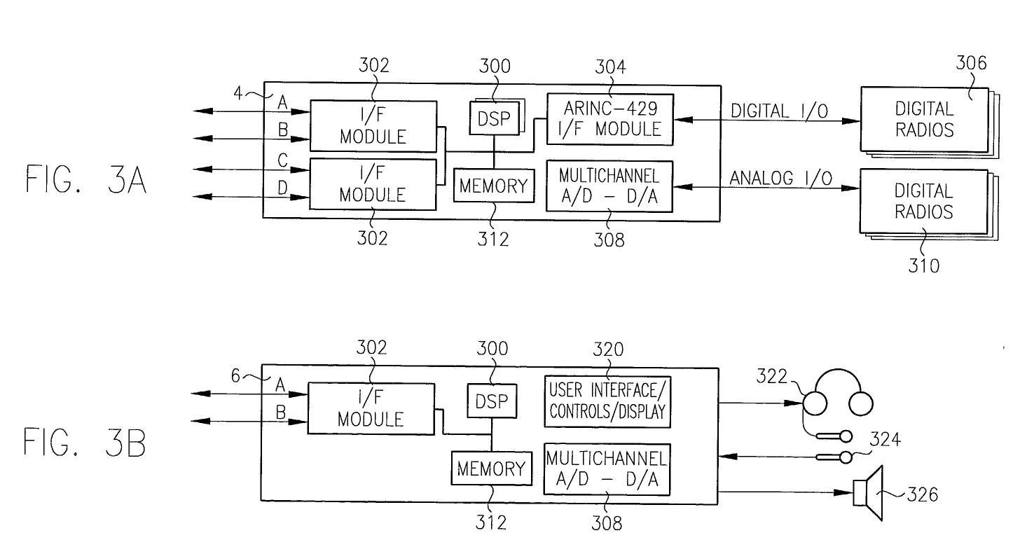

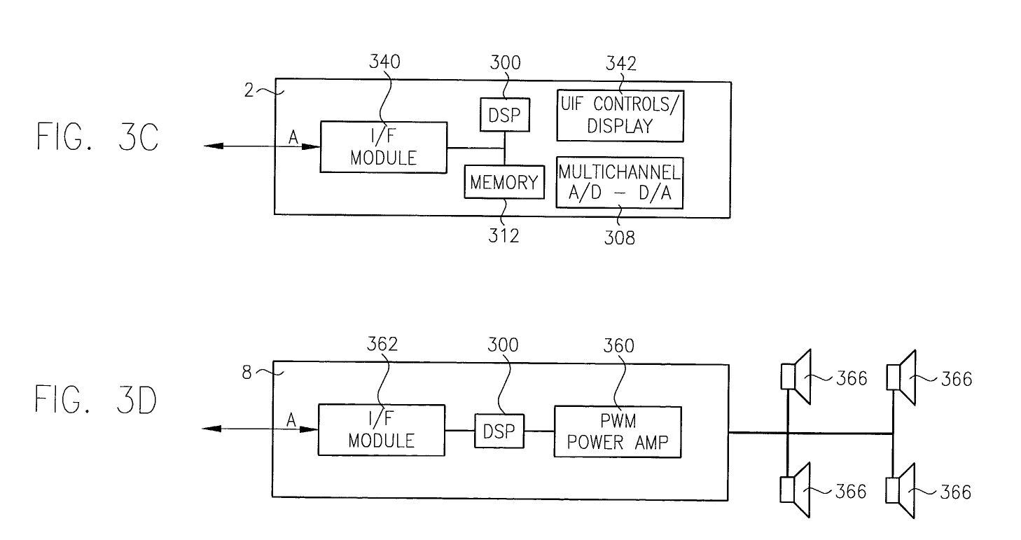

Focusing now on the components of the system 10, FIG. 3A shows a typical Audio Concentrator Unit 4 configuration. FIG. 3B shows a typical Audio Control Panel 6 configuration. FIG. 3C shows a typical Audio MultiFunction Unit 2 configuration. Finally, FIG. 3D shows a typical Digital Power Amplifier 8 block diagram. System 10 components are classified as being a producer (“talker”) of data, a consumer (a “listener”) of data or both a producer (“talker”) and a consumer (“listener”) of data.

Turning to FIG. 3A, a typical Audio Concentrator Unit (ACU) (hub node) 4 comprises one or more powerful Digital Signal Processing (DSP) Central Processing Units (CPU) 300 which provide substantial audio signal processing power for mixing, routing, filtering and other functions applied to the channels. It also contains one or more printed circuit board (PCB) daughter card interface modules 302 that receive, synchronize, and send packets of TDM signals on two bidirectional links (e.g. links A and B for the first PCB daughter card in FIG. 3A) per interface module 302. The Audio Concentrator Unit 4 also contains one or more ARINC-429 interface modules 304 that provide a connection to a digital radio 306 such as, for example, a Collins Proline 21 radio system. This connection allows an Audio Concentrator Unit 4 to send and receive digital audio radio signals on appropriate assigned channels. Additionally, a multi-channel analog-to-digital (A/D) and digital-to-analog (D/A) I/O module 308 is provided on the Audio Concentrator Unit 4 to enable connection to legacy analog radio systems 310 or any line level audio source. Finally, the Audio Concentrator Unit 4 has a memory 312 for storing DSP programs, data, and configuration information about assignments and allocation of system 10 channels.

Typically, Audio Concentrator Units 4 are both producers of audio data for the radio receive channels to which they are assigned, and consumers of data for the radio transmit channels to which they are assigned. For example if one Audio Concentrator Unit 4 is connected to a VHF digital communications radio called COM1, then it would receive digital audio data from COM1 and transmit a digital signal representing the audio data to an assigned channel number. Thus, this particular Audio Concentrator Unit 4 receiving the COM1 data (“listening”) would also transmit the COM1 data to all appropriate devices (“talking”) on the on the assigned channel.

As just described for radio source signals, when the Audio Concentrator Unit (hub) receives a word of data that it should pass on to a leaf node or another hub node, it repeats the word of data, sending it out one or more ports simultaneously. However, because such repeating requires some delay, the repeated words cannot be retransmitted in the TDM cycle in which they were received. Consequently, they are transmitted in the next TDM cycle, 125 usec later. So, if a signal comes from a source, through a hub, to a listener, it is delayed by 125 usec. If it is retransmitted by 3 hubs before reaching its leaf node destination, it is delayed by 375 usec, which is still a small enough delay that it cannot be detected by a human. By contrast, the leaf nodes, which include Digital Power Amplifiers 8, Audio Control Panels 6, and Audio MultiFunction Units 2, do not repeat signals they receive. They can transmit directly from one to another, but they cannot repeat.

In FIG. 3B, a typical Audio Control Panel (ACP) 6 contains a single interface module 302 that, like an Audio Concentrator Unit 4, receives, synchronizes, and sends packets of TDM system 10 signals on two bi-directional links (again links A and B). Further, a typical Audio Control Panel 6 contains a moderately powerful DSP 300 and a memory 312 for DSP programs and data. Additionally, a multi-channel A/D and D/A I/O module 308 is provided for an interface to several input and output devices such as, for example, multiple headphones 322 (with boom microphone), a hand microphone 324, and/or a local speaker 326. Finally, the Audio Control Panel includes user interface circuitry 320 to enable control and display of information relating to the various channels.

Audio Control Panels 6 also provide producer/consumer functionality since they act as an interface for a human to the system. For example, Audio Control Panels 6 can consume data from selected channels such as SELCAL (Selective Calling from one Audio Concentrator Unit 6 to another) from other data producers. This data consumption is typically in the form of audio playback to crewmembers via a headset 322, or cabin speaker 326. Continuing the example, Audio Control Panels 6 produce data to the system by transmitting data to a channel. Typical examples of transmitting data to the system 10 at Audio Control Panel (ACP)s 6 include whenever a microphone with voice activation is spoken into (hot mic), whenever a Push-To-Talk (PTT) button is pressed on a pilot/copilot/observer yoke, or whenever other input audio sources (CD audio player, audio from an onboard cabin entertainment system, etc.) are activated.

In FIG. 3C, a typical Audio MultiFunction Unit 2 houses an interface module 340 that has only a single bi-directional link to the system 10. The Audio MultiFunction Unit 2, like the Audio Control Panel (ACP) 6 typically has a moderately powerful DSP 300, and a large amount of FLASH memory 312 for storing configuration and audio playback data. A typical Audio MultiFunction Unit 2 has a few channels of analog I/O for auxiliary analog inputs and outputs configured in a multi-channel A/D and D/A I/O module 308. This module provides an interface to relatively few input and output devices such as, for example, a CPDLC device (not shown).

A typical Audio MultiFunction Unit 2 produces a large amount of data stored in its memory 312 on the system 10 for use in one of its many modes. Such examples of this data include aural checklist data for an automated checklist system, prerecorded passenger cabin briefing, voice prompts, alerts, warnings, or any other uses for playback of previously recorded audio data. The Audio MultiFunction Unit 2 also consumes data from the system 10 by monitoring Air Traffic Control DataLink messages placed on the system 10 from one of the Audio Concentrator Units 4 connected to a suitable DataLink radio component such as a VHF datalink radio.

Finally, in FIG. 3D, a typical Digital Power Amplifier 8 contains a single, input-only interface module 362 that is programmed only to receive data from particular assigned channels. A low power DSP 300 is used to convert the serial, digital data into a Pulse Width Modulated signal that is suitable for driving MOSFET type power amplifier circuits 360 for efficient and clean conversion of the digital audio signal on the assigned channels to playback on output devices 366. The Digital Power Amplifier 8 is only a consumer of data from the system 10 as it provides amplification to assigned channels on the network.

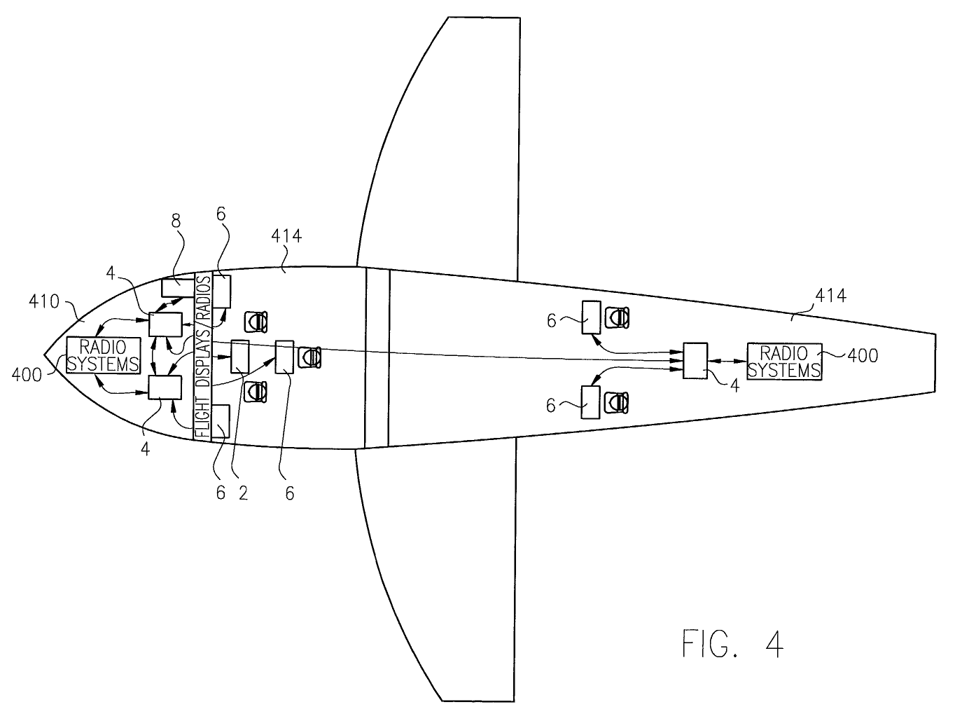

The present invention is directed to a communication system that can reside in a vehicle. For the purposes of this disclosure, a vehicle includes any movable structure capable of containing people, such as a car, boat, or airplane. FIG. 4 depicts one such vehicle, an airplane, wherein the invention can be practiced. In this example, FIG. 4 shows strategic placement of the various components of a typical system. There are three Audio Concentrator Units 4 placed in key areas in the airplane where several communications devices are likely to reside. For example, various system radios 400 are communicatively connected to appropriate Audio Concentrator Units 4 in the Avionics Bay 410 as well as in the AFT Communications Stations 414.

As was discussed above, the Audio Concentrator Units 4 provide hub functionality for the system. Thus strategic placement of Audio Concentrator Units 4 becomes important to an efficient system. In the case of an airplane, typically, two Audio Concentrator Units 4 will reside in the Avionics Bay 410 because of the critical importance of communications systems therein as well as federal regulation requirements for redundancy. Alternatively, a system can function with a single Audio Concentrator Unit 4 acting as the only hub for the system 10.

Turning back to FIG. 4, various Audio Control Panels 6, are installed at several on-board locations, are communicatively connected, either non-redundantly or redundantly, to one of the three Audio Concentrator Units 4. A redundant communication connection allows for a failure in a primary communication path in that a secondary communication path is provided. Use of the secondary path is activated once a loss of the link synchronization is detected via the PID 64 bit code method described above. Again, as discussed above, Audio Control Panels 6 provide a user interface for the system. For reasons of redundancy, each Audio Control Panel (ACP) 6 is typically communicatively connected to at least two Audio Concentrator Units 4. Furthermore, each Audio Concentrator Unit 4 is typically in a communication connection with all other Audio Concentrator Units 4 as well. Pilot and Copilot Audio Control Panels 6 are typically redundantly connected to the radios via both Audio Concentrator Units 4. Note in particular that, in this example, there is one single communication connection from the front to the back of the aircraft. Additional redundancy may typically be added because it only requires a free link somewhere within the system and an independent path to the radio or audio resources needed.

Communications connections are typically configured according to a static routing table. The static routing table encompasses multiple fundamental configuration concepts. These may include bus parameter assignments for allowing mutually exclusive interfacing within the audio bus channel space, source/sink channel definitions, discrete mapping parameters, panel control assignments for panel devices), event handling rules, interface properties, and other device unique configuration data. Appropriate portions of the table are stored in memory within all devices in a compatible system whereas certain other portions are unique to the device into which it is installed. Once configured, each device then has the capability of determining how to handle each word of early frame. All received data is determined to be either passed along to another node, consumed by the current node, or both. For example, a word on particular channel received at a node could be simultaneously routed to an audio output circuit at the node, routed to the first channel of a dual interface module, and not routed to the second channel of the dual interface module.

Finally, in FIG. 4, a Digital Power Amplifier 8 is connected to one of the Audio Concentrator Units 4 in the Avionics Bay 410 and an Audio MultiFunction Unit 2 is connected to one of the Audio Concentrator Units 4 in the Flight Deck 412.

A system as shown in FIG. 4 provides a communication network between all nodes through the various interconnects. In one embodiment, each interconnection on the system 10 uses a standard known as Low Voltage Differential Signaling (LVDS) in the physical transport of the high-speed serial data. More specifically, the cabling used to accomplish the LVDS link is Quadrax cabling which is highly suitable for Ethernet general data communications applications.

The embodiments of the invention in which an exclusive property or privilege is claimed are defined as follows:

1. A communications system within a vehicle comprising:
(a) a plurality of nodes, each node having a network interface component connected to a communication network, the communication network configured to communicate data in a serial, time-division multiplexed (TDM) format using an embedded clock signal;
(b) a primary master clock within one of the plurality of nodes that provides a clock signal for the embedded clock signal for the TDM format;
(c) at least one input device connected to at least one of the plurality of the nodes, the input device converting analog input to a digital format at a sample rate determined by the primary master clock; and
(d) at least one output device connected to at least one of the plurality of nodes, the output device converting digital data to an analog format at a sample rate determined by the primary master clock.

2. The communications system of claim 1, wherein the communication network has a first communication link connecting network interface components in each of two nodes and further comprises a second communication link connected network interface components in the two nodes.

3. The communications system of claim 1, further comprising a secondary master clock within one of the plurality of nodes that is not the node containing the master clock.

4. The communications system of claim 3, wherein the secondary master clock provides a clock signal for the embedded clock signal for the TDM format if the primary master clock is disabled.

5. The communications system of claim 1, wherein the TDM format comprises a mix of multi-bit samples divided into a plurality of channels, the sample rate determined by the embedded clock signal.

6. The communications system of claim 1, wherein at least one of the input devices is a Controller-Pilot Data Link Communication device.

7. The communications system of claim 1, wherein at least one of the at least one output device is a Controller-Pilot Data Link Communication device.

8. The communications system of claim 1, wherein at least one of the input devices is an ARINC-429 standard device.

9. The communications system of claim 1, wherein at least one of the output devices is an ARINC-429 standard device.

10. The communications system of claim 1 further comprising a means for excluding one of the nodes from communicating to another one of the nodes.

11. The communications system of claim 1, wherein the communication network uses Low Voltage Differential Signaling.

12. A communications system within a vehicle comprising:
(a) a plurality of nodes, each node having a network interface component connected to a communication network, the communication network configured to communicate data in a serial, time-division multiplexed (TDM) format;
(b) at least one primary communication path between each pair of nodes of the plurality of nodes,
(c) at least one secondary communication path between at least one pair of nodes of the plurality of nodes, the secondary communication path being a different communication path than the respective primary communication path between the nodes.

13. The communications system of claim 12 wherein each primary communication path is the shortest communication path between two nodes.

14. The communications system of claim 12 wherein the nodes comprise leaf nodes and hub nodes and the hub nodes each include a repeater circuit for repeating the signal to another node.

15. The communications system of claim 12 wherein the TDM format used on the communications network uses an embedded clock provided by a clock signal from a primary master clock is one of the plurality of nodes.

16. The communications system of claim 15 wherein the TDM format comprises a mix of multi-bit samples divided into a plurality of channels, the sample rate determined by the embedded clock signal.

17. The communications system of claim 12 wherein each primary communication path and each secondary communication path is determined by a programmable table of communication paths for the communication network.

18. The communications system of claim 12 wherein access to the programmable table of communication paths is password protected.

19. A communications system within a vehicle comprising:
(a) a plurality of nodes, each node having a network interface component connected to a communication network, the communication network configured to communicate data in a serial, time-division multiplexed (TDM) format on Low Voltage Differential Signaling circuits;
(b) at least one input device connected to at least one of the plurality of the nodes, the input device converting analog input to a digital format at a predetermined sample rate; and
(d) at least one output device connected to at least one of the plurality of nodes, the output device converting digital data to an analog format at the predetermined sample rate.

20. The communications system of claim 19 wherein the TDM format used on the communications network uses an embedded clock provided by a clock signal from a primary master clock in one of the nodes.

21. The communications system of claim 20, wherein the TDM format comprises a mix of multi-bit samples divided into a plurality of channels, the sample rate determined by the embedded clock signal.

22. The communications system of claim 19 wherein the nodes comprise leaf nodes and hub nodes and the hub nodes each include a repeater circuit for repeating the signal on a Low Voltage Differential Signaling circuit to another node.

23. A communications system within a vehicle comprising:
(a) a plurality of nodes, each node having a network interface component connected to a communication network, the communication network configured to communicate data in a serial, time-division multiplexed (TDM) format, the format comprising a plurality of channels containing packets of multiplexed data;
(b) at least one input device connected to at least one of the plurality of nodes, the input device converting analog input to a digital format at a predetermined sample rate for one of the channels; and
(c) at least one output device connected to at least one of the plurality of nodes, the output device converting digital data from the channel to an analog format at the predetermined sample rate.

24. The communications system of claim 23 wherein the TDM format used on the communications network uses an embedded clock provided by a clock signal from a primary master clock in one of the nodes.

25. The communications system of claim 24, wherein the TDM format comprises a mix of multi-bit samples divided into a plurality of the channels.

26. The communications system of claim 23 wherein each channel comprises a minimum sample rate of 8 kHz.

27. The communications system of claim 23 wherein the communication network has at least 100 channels.

28. The communications system of claim 23 wherein the data communicated on the communication network is audio data.

29. The communications system of claim 23 wherein the data communicated on the communication network is video data.

30. The communications system of claim 23 wherein the data communicated on the communication network is aggregated into multiple channel transmissions for higher bandwidth data.
